(19) United States
(12) Patent Application Publication
(10) Pub. No.: US 2008/0179348 A1
(43) Pub. Date: Jul. 31, 2008

(54) Drainage system

(76) Inventor: Megan G. Schrieber, Hinsdale, IL (US)

Correspondence Address: Ms. Soula Skokos, Suite 220, 1100 Jorie Boulevard, Oak Brook, IL, 60523, US

(21) Appl. No.: 11/700,459

(22) Filed: Jan. 31, 2007

(51) Int. Cl. B67D 5/64

(52) U.S. Cl. 222/173; 222/626; 222/333

(57) ABSTRACT

A system for withdrawing water, comprising at least one withdrawal passage through which water will be withdrawn, an apparatus that is fitted to one end of the withdrawal passage to aid the user in withdrawing water from a container, means such as a pump with a reversible motor is connected to the opposite end of the withdrawal passage for generating pressure differential to withdraw water through said withdrawal passage, and a drain passage that connects to the withdrawal passage to lead the withdrawn water to a drain.

### BACKGROUND OF THE INVENTION

1. Field of the Invention

The present invention relates to drainage systems and more specifically to a drainage system to be used with current pot filler systems.

2. Description of the Related Art

A drawback to current pot filler systems is that current systems solely consist of pot filler stations or faucets that are connected to the main plumbing of a residence and provide a source of water a distance away from a traditional kitchen sink and faucet. The purpose of a pot filler system is to allow the user to fill a cooking pot or potted plant at a pot filler station or faucet with water as opposed to requiring the user to fill such a pot at a traditional kitchen faucet.

With current systems, once the user has filled a pot or container with water at a pot filler faucet, the pot is then quite heavy to carry back to the kitchen sink to drain or empty the water from the pot or container. It would be desirable to enable the user to drain or empty the pot or container at the pot filler station to obviate the need to return the heavy pot or container to the kitchen sink or nearest drain.

### SUMMARY OF THE INVENTION

Briefly described, the present invention, in one embodiment, may be a system for withdrawing water, comprising at least one withdrawal passage through which water will be withdrawn, an apparatus that is fitted to one end of the withdrawal passage to aid the user in withdrawing water from a container, means such as a pump with a reversible motor is connected to the opposite end of the withdrawal passage for generating pressure differential to withdraw water through said withdrawal passage, and a drain passage that connects to the withdrawal passage to lead the withdrawn water to a drain.

In one embodiment of the invention, the one end of the withdrawal passage may be adapted to be fitted to an apparatus that allows the user to place such apparatus into a container or pot to withdraw water from such container or pot. Said apparatus may be a flexible, retractable passage that is connected at one end to the withdrawal passage and at the opposite end is connected to a drainage head through which water enters the flexible, retractable passage into the water withdrawal passage. Said drainage head is comprised of a top portion that may have a single aperture or may have a plurality of apertures, and a solid bottom that is connected to the flexible, retractable passage. The top portion of the drainage head allows the user to drain water or liquid from a container or pot that also contains solid particles such as cooked food. The drainage head acts as a sieve to withdraw only the water or liquid from a container or pot. The top portion of the drainage head may be semi-spherical or domed in shape, rectilinear, elliptical, triangular, polygonal, or any other standard shape. The top portion of the drainage head may consist of a wire mesh or wire grate to act as a sieve. Alternatively, the top portion of the drainage head may have a plurality of apertures to act as a sieve. Alternatively, the top portion of the drainage head may have a single aperture to act as a sieve. The top portion of the drainage head may be interchangeable to allow the user to connect top portions with different types of apertures to the drainage head.

In another embodiment, the present invention may be a system for both supplying and withdrawing water, comprising at least one supply passage through which water will be supplied and at least one withdrawal passage through which water will be withdrawn, an apparatus that is fitted to one end of the withdrawal passage to aid the user in withdrawing water from a container, means such as a pump with a reversible motor is connected to the opposite end of the withdrawal passage for generating pressure differential to withdraw water through said withdrawal passage, and a drain passage that connects to the withdrawal passage to lead the withdrawn water to a drain.

In one embodiment of the invention, one end of the supply passage may be adapted to be fitted to a faucet apparatus to provide water to a user. Alternatively, one end of the supply passage may be adapted to fit to another passage such as a flexible passage or retractable, flexible passage and head such to provide water to a user a predetermined distance from the end of the supply passage.

### BRIEF DESCRIPTION OF THE DRAWINGS

FIG. 1 is a perspective view of a pot filler and drainage system designed in accordance with an embodiment of the present invention;

FIG. 2a is a perspective view of a drainage head and flexible, retractable passage as shown in FIG. 1; and

FIG. 2b is a side view of a drainage head and flexible, retractable passage as shown in FIG. 1.

### DETAILED DESCRIPTION OF DRAWINGS

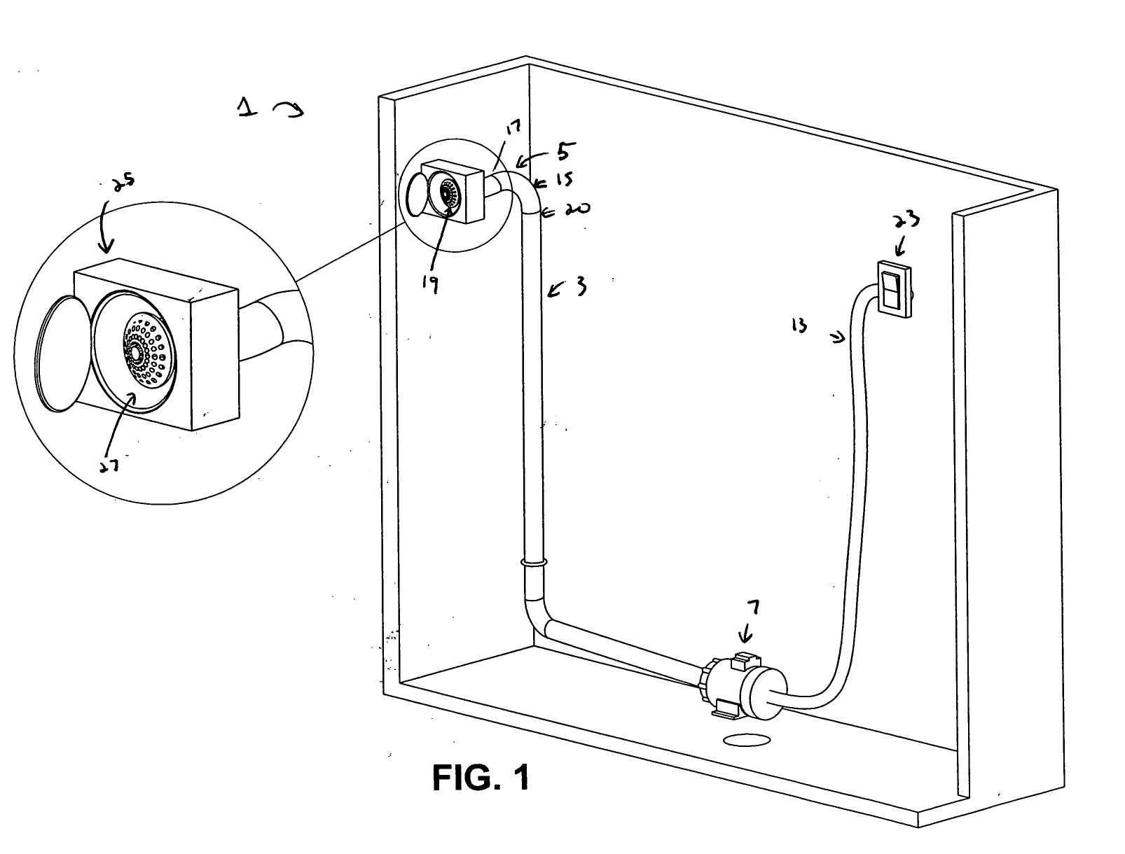

FIG. 1 illustrates an embodiment of a drainage system 1. The system 1 includes at least one withdrawal passage 3 through which water will be withdrawn, an apparatus 5 that is fitted to one end of the withdrawal passage 3 to aid the user in withdrawing water from a container, means such as a pump 7 with a reversible motor is connected to the opposite end 11 of the withdrawal passage 3 for generating pressure differential to withdraw water through said withdrawal passage 3, and a drain passage 13 that connects to the withdrawal passage to lead the withdrawn water to a drain.

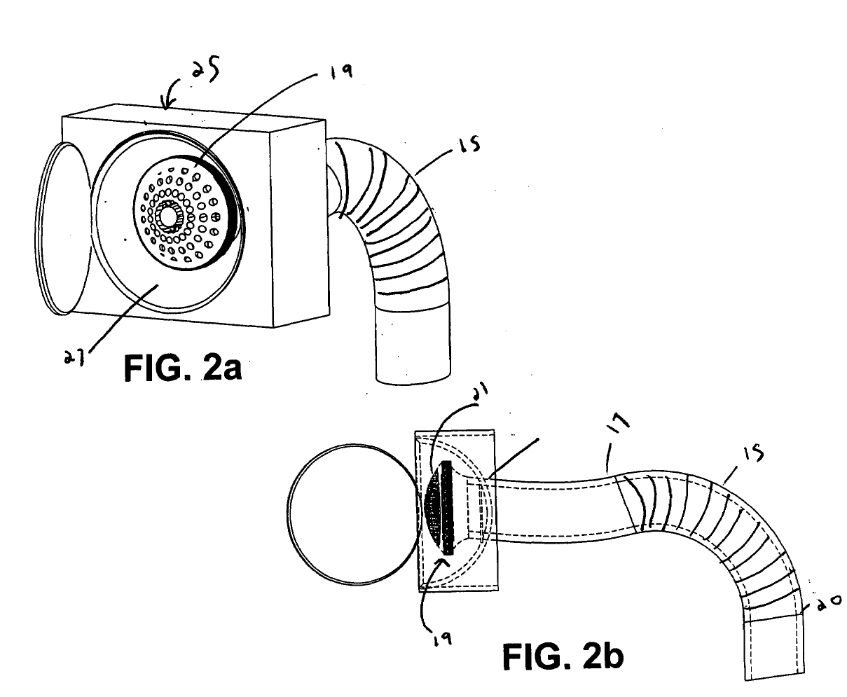

In one embodiment of the invention, the one end of the withdrawal passage 3 may be adapted to be fitted to an apparatus 5 that allows the user to place such apparatus into a container or pot to withdraw water from such container or pot. As illustrated in FIG. 2b, said apparatus 5 may be a flexible, retractable passage 15 that is connected at one end 20 to the withdrawal passage 3 and at the opposite end 17 is connected to a drainage head 19 through which water enters the flexible, retractable passage 15 into the water withdrawal passage 3. As shown in FIG. 2a, said drainage head 19 is comprised of a top portion 21 that may have a plurality of apertures and a solid bottom (not shown) that is connected to the flexible, retractable passage 15. In the alternative, the top portion 21 may have a single aperture. The top portion of the drainage head 19 allows the user to drain water or liquid from a container or pot that also contains solid particles such as cooked food. The drainage head 19 acts as a sieve to withdraw only the water or liquid from a container or pot. The top portion 21 of the drainage head 19 may be semi-spherical or domed in shape, rectilinear, elliptical, triangular, polygonal, or any other standard shape.

In one embodiment of the present invention, the top portion 21 of the drainage head 19 may consist of a wire mesh or wire grate to act as a sieve. Alternatively, the top portion 21 of the drainage head 19 may have a plurality of apertures, as shown in FIG. 2a to act as a sieve. Alternatively, the top portion 21 of the drainage head 19 may have a single aperture to act as a sieve. The top portion 21 of the drainage head 19 may be interchangeable to allow the user to connect top portions with different types of apertures to the drainage head 19.

In a preferred embodiment of the present invention, the means such as a pump 7 with a reversible motor is controlled by a manual electrical switch 23 which allows the user to turn the pump 7 on whereby when the user places the drainage head 19 into a container or pot containing liquid, the liquid will be withdrawn from the container or pot and be forced through the flexible, retractable passage 15 into the withdrawal passage 3, and then into the drain passage 13 which leads the liquid to the drain. The user is then enabled to withdraw water or liquid from a container or pot without having to physically lift the container or pot and pour out the liquid.

One of the advantages of the present invention is its compactness and that the drainage system 1 can fit within a cabinet or behind the paneling of a user's kitchen area and be easily installed. Preferably, the drainage head 19 may be easily accessible to the user by mounting the drainage head 19 and the end 17 of the flexible, retractable passage 15 that is connected to the drainage head 19 within an access panel 25 that has an opening 27. The user may access the drainage head 19 through the opening 27 to pull the drainage head 19 and flexible, retractable passage 15 through said opening 27 to place the drainage head 19 in a container or pot containing liquid. In a preferred embodiment, a ring or finger pull 29 is attached to the drainage head 19 to allow the user to easily pull the drainage head 19 out of the access panel 25.

In another embodiment, the drainage system 1 may be a pot filler and drainage system for both supplying and withdrawing water, comprising at least one supply passage through which water will be supplied and at least one withdrawal passage through which water will be withdrawn, an apparatus that is fitted to one end of the withdrawal passage to aid the user in withdrawing water from a container, means such as a pump with a reversible motor is connected to the opposite end of the withdrawal passage for generating pressure differential to withdraw water through said withdrawal passage, and a drain passage that connects to the withdrawal passage to lead the withdrawn water to a drain.

In one embodiment of the invention, the one end of the supply passage may be adapted to be fitted to a faucet apparatus to provide water to a user. Alternatively, the one end of the supply passage may be adapted to fit to another passage such as a flexible passage or retractable, flexible passage and head such to provide water to a user a predetermined distance from the end of the first passage. The opposite end of the supply passage is connected to a water line that supplies potable water through said water line to thereby supply water through the supply passage to the user.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

I claim:

1. A system for withdrawing water, comprising:
at least one withdrawal passage through which water will be withdrawn;
an apparatus that is fitted to one end of the withdrawal passage to aid the user in withdrawing water from a container:
means for generating pressure differential to withdraw water through said withdrawal passage is connected to the opposite end of the withdrawal passage; and
a drain passage that connects to the withdrawal passage to lead the withdrawn water to a drain.

2. A system as claimed in claim 1, wherein the apparatus is a drainage head.

3. A system as claimed in claim 2, wherein the drainage head has a single aperture.

4. A system as claimed in claim 2, wherein the drainage head has a plurality of apertures.

5. A system as claimed in claim 2, wherein the drainage head has a wire grate.

6. A system as claimed in claim 2, wherein said means for generating pressure differential is a pump with a reversible motor.

7. A system as claimed in claim 1, wherein the apparatus is a flexible, retractable passage that is connected at one end to the withdrawal passage and at the opposite end is connected to a drainage head.

8. A system for supplying and withdrawing water comprising:
at least one supply passage through which water will be supplied;
at least one withdrawal passage through which water will be withdrawn;
an apparatus that is fitted to one end of the withdrawal passage to aid in withdrawing water from a container;
means for generating pressure differential to withdraw water through said withdrawal passage is connected to the opposite end of the withdrawal passage; and,
and a drain passage that connects to the withdrawal passage to lead the withdrawn water to a drain.

9. A system as claimed in claim 8, wherein the apparatus is a drainage head.

10. A system as claimed in claim 9, wherein the drainage head has a single aperture.

11. A system as claimed in claim 9, wherein the drainage head has a plurality of apertures.

12. A system as claimed in claim 9, wherein the drainage head has a wire grate.

13. A system as claimed in claim 9, wherein the apparatus is a flexible, retractable passage that is connected at one end to the withdrawal passage and at the opposite end is connected to a drainage head.

14. A system as claimed in claim 8, wherein said means for generating pressure differential is a pump with a reversible motor.

15. A system for withdrawing water, comprising:
at least one withdrawal passage through which water will be withdrawn;
a flexible, retractable passage that is connected at one end to the withdrawal passage and at the opposite end is connected to a drainage head to aid the user in withdrawing water from a container:
means for generating pressure differential to withdraw water through said withdrawal passage is connected to the opposite end of the withdrawal passage; and
a drain passage that connects to the withdrawal passage to lead the withdrawn water to a drain.

16. A system as claimed in claim 15, wherein the drainage head has a single aperture.

17. A system as claimed in claim 15, wherein the drainage head has a plurality of apertures.

18. A system as claimed in claim 15, wherein the drainage head has a wire grate.

19. A system as claimed in claim 15, wherein said means for generating pressure differential is a pump with a reversible motor.
